(19) United States
(12) Patent Application Publication
(10) Pub. No.: US 2015/0187494 A1
(43) Pub. Date: Jul. 2, 2015

(54) PROCESS FOR PREPARING RARE EARTH MAGNETS

(71) Applicant: Hyundai Motor Company, Seoul (KR)

(72) Inventors: Jae Ryung Lee, Hwaseong (KR); Kun Min Park, Suwon (KR); Yen Jun Chung, Seoul (KR)

(21) Appl. No.: 14/513,789

(22) Filed: Oct. 14, 2014

(30) Foreign Application Priority Data
Dec. 31, 2013 (KR) 10-2013-0168492

(51) Int. Cl. H01F 41/02; H01F 41/00; H01F 7/02; H01F 1/057

(52) U.S. Cl. CPC H01F 41/0293; H01F 1/0577; H01F 1/0572; H01F 41/005; H01F 7/02

(57) ABSTRACT

Disclosed is a method of producing a rare earth permanent magnet, comprising: obtaining a NdFeB sintered magnet; applying a mixed powder including a Zn-containing metal and a metal compound containing Tb or Dy onto a surface of the sintered magnet; and heat-treating the sintered magnet having the mixed powder applied on its surface.

### CROSS-REFERENCE TO RELATED APPLICATION

This application claims priority to and the benefit of Korean Patent Application No. 10-2013-0168492 filed in the Korean Intellectual Property Office on Dec. 31, 2013, the entire contents of which are incorporated herein by reference.

### TECHNICAL FIELD

The present disclosure relates to a method of producing rare earth magnets. The method may include conducting a heat-treatment for diffusion on a magnet having a mixture of a Zn-containing metal or alloy thereof and a rare earth compound such as a fluoride applied on its surface. The present invention also relates to rare earth magnets produced by the method of the invention.

### BACKGROUND

Rare earth permanent magnets such as Nd—Fe—B-based permanent magnets have excellent magnetic properties and have been used for a smaller motor having higher power. Furthermore, utility thereof are growing in various ranges of applications such as permanent magnets for various home appliances and vehicles.

As one of magnetic properties of the magnet, residual magnetic flux density may depend on a major phase fraction of NdFeB, a density, and a degree of magnetic orientation. Coercive force may be related to durability of the magnet against an external magnetic field or heat. The coercive force may be affected by a micro-structure of a crystalline structure of the magnet. In addition, a smaller crystal grain size and a uniform distribution on the grain boundary may have an effect on the coercive force. In an effort to enhance the coercive force of the NdFeB permanent magnet, substitution of a Nd component with other elements such as Dy or Tb has been suggested to increase magnetic anisotropic energy. However, the element such as Dy or Tb is so expensive, such that such production costs may inevitably increase for the permanent magnet and thus price competitiveness may decrease.

In the related arts, to increase the coercive force of the permanent magnet, a two-alloy method has been developed. In such method, two different alloy powders having different compositions are mixed and are subjected to pressurization under a magnetic field and a sintering process to produce a magnet. In the two-alloy method, a powder of Re₂Fe₁₄B, in which Re is Nd or Pr, an alloy powder including Dy, Tb, and another additional element (such as Al, Ti, Mo, or Ho) are mixed to prepare a magnet. The resulting magnet was expected to provide a high coercive force while minimizing a decrease of the residual magnetic flux density because the additive elements such as Dy and Tb are substantially reduced along the grain boundaries of Re₂Fe₁₄B while they are localized near grain boundaries. In this method, however, Dy and Tb may diffuse into the interior of the grain during the sintering, such that the expected results have not been obtained.

In the related arts, a “grain boundary diffusion method” has been suggested as a method for increasing the coercive force, making Dy or Tb diffuse from a surface of an NdFeB permanent magnet into the grain boundaries. In the grain boundary diffusion method, Dy or Tb is attached to a surface of a NdFeB sintered magnet and the resulting magnet is heated for example to 700 to 1000° C., allowing Dy or Tb to go through the grain boundary of the sintered body and penetrate thereinto. As a result, a grain boundary phase as a rare earth rich phase may be present on the grain boundary. Further, since the melting point of the Nd rich phase may be less than that of the magnetic particle and may be melted when it is heated to such a temperature, the Dy and the Tb may be dissolved in a liquid phase that is present on the grain boundary, and thus they may diffuse from the surface of the sintered body into the particle. A material may diffuse in a liquid state much faster than in a solid state, and thus the rate of diffusing through the melted grain boundary into the sintered body may sharply increase. By using the difference in the diffusion rate, a state in which the concentration of the Dy and/or the Tb is elevated only in a region extremely near the grain boundary of the main phase particle of the sintered body such as the surface region may be obtained. As such, as the concentrations of the Dy and/or the Tb increase, the residual magnetic flux density (Br) of the magnet may decrease. However, in the magnet prepared from the grain boundary diffusion method, a region having an increased concentration of the Dy and/or the Tb may be limited only to the surface region of the main phase particle, and thus a total value of the residual magnetic flux density of the magnet may have barely any decrease. Therefore, the magnet prepared from the grain boundary diffusion method may have enhanced coercive force but the residual magnetic flux density maintains as same as the NdFeB sintered magnet that does not include Dy or Tb.

Moreover, in the grain boundary diffusion method of the related arts, a rare earth metal such as Yb, Dy, Pr, and Tb or a metal such as Al and Ta is applied to a surface of the Nd—Fe—B magnet using vapor deposition or sputtering to form a layer and the resulting magnet having the layer may be heat-treated. Alternatively, a rare earth inorganic compound such as a fluoride or oxide is applied to a surface of a sintered body and then the resulting product is heat-treated. In the grain boundary diffusion method, elements such as Dy and Tb disposed on the surface of the sintered body may diffuse into the inner part of the sintered body via a path of the grain boundary of the sintered body. Therefore, the Dy or the Tb may be concentrated substantially near the grain boundary of the major phase and thus the grain boundary diffusion method may produce a magnet having a more ideal structure than the two-alloy method. Further, such a structure may transform with a less decrease in the residual magnetic flux density together with a higher value of coercive force. However, as the grain boundary diffusion method mostly includes vapor deposition and sputtering, it has many disadvantages in terms of the facility or the process and productivity thereof is substantially reduced. Therefore, urgent needs still remain for developing a method which provides uniformly enhanced the coercive force in the permanent magnet at a low cost and with high productivity.

The above information disclosed in this Background section is only for enhancement of understanding of the background of the invention and therefore it may contain information that does not form the prior art that is already known in this country to a person of ordinary skill in the art.

### SUMMARY

Disclosed are methods of producing a rare earth permanent magnet having enhanced coercive force and increased corrosion resistance while suppressing deterioration in residual magnetic flux density. In addition, the present invention provides a rare earth permanent magnet produced by the methods of the invention.

In one aspect, a method of producing a rare earth permanent magnet is provided.

In an exemplary embodiment, the method may include:

obtaining a NdFeB sintered magnet;

applying a mixed powder including a Zn-containing metal and a metal compound containing Tb or Dy onto a surface of the sintered magnet; and

heat-treating the sintered magnet having the mixed powder applied on its surface.

In particular, the NdFeB sintered magnet may have a composition of Chemical Formula 1:

ReₐM_{b}Fe_{c}B_{d} [Chemical Formula 1]

Re may be at least one rare earth metal selected from the group consisting of Nd, Dy, Tb, and Pr, and Re essentially includes Nd; M may be at least one metal selected from the group consisting of Co, Al, Cu, Ga, Zr, and Nb; a is a real number of 25 to 35; b is a real number of 0 to 10; d is a real number of 0.1 to 5; c is a balance when a+b+c+d=100, and each of a, b, c, and d represents a weight percentage (wt %) of each element, respectively, based on the total weight of the NdFeB sintered magnet.

In certain exemplary embodiments, the mixed powder may further include at least one metal selected from the group consisting of Cu, Co, Sn, Al, Ni, and Fe.

In yet certain exemplary embodiments, in the mixed powder, the Zn-containing metal may include a Zn metal powder, an alloy powder including Zn and a rare earth element, an alloy powder of a first metal and Zn. In particular, the first metal may be at least one metal selected from the group consisting of Cu, Co, Sn, Al, Ni, and Fe, and a combination thereof.

In still certain exemplary embodiments, in the mixed powder, the metal compound containing Tb or Dy may include a Tb metal powder, a Dy metal powder, a Tb fluoride, a Tb hydride, a Tb oxide, a Dy fluoride, a Dy hydride, a Dy oxide, a Tb-transition metal fluoride, a Tb-transition metal hydride, a Tb-transition metal oxide, a Dy-transition metal fluoride, a Dy-transition metal hydride, a Dy-transition metal oxide, or a combination thereof.

In certain exemplary embodiments, the mixed powder may have a Zn content of about 0.3 wt % to about 50 wt %. Particularly, the mixed powder may have a Zn content of greater than or equal to about 1 wt %.

In certain exemplary embodiments, the mixed powder may have an average particle size of less than or equal to about 10 μm. Particularly, the mixed powder may have an average particle size ranging from about 1 μm to about 5 μm.

In certain exemplary embodiments, the mixed powder may be a simple mixture including a Zn-containing metal, a metal compound containing Tb or Dy, and optionally at least one metal selected from the group consisting of Cu, Co, Sn, Al, Ni, and Fe. As used herein, the term “simple mixture” refers to a mixture that may be obtained by mixing components of the mixture, for example, manually or physically.

In certain exemplary embodiments, the mixed powder may be a product of alloying a Zn-containing metal, a metal compound containing Tb or Dy, and optionally at least one metal selected from the group consisting of Cu, Co, Sn, Al, Ni, and Fe, and of pulverizing an alloy thus obtained.

In yet certain exemplary embodiments, the mixed powder may be a product of melting a Zn-containing metal, a metal compound containing Tb or Dy, and optionally at least one metal selected from the group consisting of Cu, Co, Sn, Al, Ni, and Fe, and of pulverizing an alloy thus obtained. Alternatively, the mixed powder may be a product by preparing a solid solution comprising the same as described above and by pulverizing a solidified product after solidification.

In certain exemplary embodiments, the applying the mixed powder including a Zn-containing metal and a metal compound containing Tb or Dy onto the surface of the sintered magnet may include immersing the sintered magnet in a suspension containing the mixed powder in a suspension solvent; removing the magnet having the suspension attached to a surface thereof from the suspension; and drying the magnet.

In yet certain exemplary embodiments, the applying the mixed powder including a Zn-containing metal and a metal compound containing Tb or Dy onto the surface of the sintered magnet may include spraying a suspension containing the mixed powder in a suspension solvent to the surface of the sintered magnet; and drying the same.

In still certain exemplary embodiments, the applying of the mixed powder including a Zn-containing metal and a metal compound containing Tb or Dy onto the surface of the sintered magnet may include: forming an adhesive layer on the surface of the sintered magnet; obtaining a mixture of the mixed powder and a metallic or ceramic impact media; placing the sintered magnet having the adhesive layer on the surface thereof in the mixture; and vibrating and agitating to the same.

In certain exemplary embodiments, the heat-treating of the sintered magnet having the mixed powder applied onto the surface thereof may be carried out under an inert gas atmosphere or under a high vacuum state. In addition, the heat-treating may be carried out at a temperature of about 700° C. to about 950° C. In particular, the heat-treating may be carried out at a temperature of about 750° C. to about 850° C. for a time period of less than or equal to about 9 hours.

In another aspect, a sintered magnet produced by the aforementioned method is also disclosed.

In certain exemplary embodiments, the sintered magnet may have corrosion resistance of greater than or equal to about 11 hours in a salt spraying test in accordance with ASTM B 117.

According to various exemplary embodiments, the produced rare earth permanent magnet may have substantially enhanced coercive force without any loss of residual magnetic flux density at a low cost and with high productivity by the methods of the invention. In addition, the obtained permanent magnet may have an increased level of corrosion resistance, and a loss of the magnet may be minimized during a subsequent process for removing an oxidized film. In particular, the grain boundary diffusion method according to an exemplary embodiment may provide the magnet with enhanced anticorrosion properties, and simultaneously, the produced magnet in the invention may have improved magnetic properties in terms of coercive force, residual magnetic flux density, maximum energy product, or edge formation in a demagnetization curve. Further, although other materials are used in the grain boundary diffusion method in the related art, the exemplary embodiments of the present invention may use an inexpensive element such as Zn and may reduce the amount of expensive rare earth element such as Tb, Dy, and the like, thereby producing a high quality magnet at a reduced production cost.

### BRIEF DESCRIPTION OF THE DRAWING

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 schematically illustrates a cross-section of an exemplary rare earth permanent magnet prepared according to an exemplary embodiment of the present invention.

### DETAILED DESCRIPTION

Advantages and characteristics of this disclosure, and a method for achieving the same, will become evident referring to the following exemplary embodiments together with the drawings attached hereto. However, this disclosure may be embodied in many different forms and is not be construed as limited to the embodiments set forth herein; rather, these embodiments are provided so that this disclosure will satisfy applicable legal requirements. Therefore, in some embodiments, well-known process technologies are not explained in detail in order to avoid vague interpretation of the present invention. If not defined otherwise, all terms (including technical and scientific terms) in the specification may be defined as commonly understood by one skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In one aspect a method of producing a rare earth permanent magnet.

In an exemplary embodiment, the method of producing the rare earth permanent magnet may include:

obtaining a NdFeB sintered magnet;

applying a mixed powder including a Zn-containing metal and a metal compound containing Tb or Dy onto a surface of the sintered magnet; and

heat-treating the sintered magnet having the mixed powder applied on its surface.

In particular, the NdFeB sintered magnet may have a composition of Chemical Formula 1:

ReₐM_{b}Fe_{c}B_{d} [Chemical Formula 1]

Re may be at least one rare earth metal selected from the group consisting of Nd, Dy, Tb, and Pr and Re essentially includes Nd. M may be at least one metal selected from the group consisting of Co, Al, Cu, Ga, Zr, and Nb. a is a real number of 25 to 35; b is a real number of 0 to 10; d is a real number of 0.1 to 5; c is a balance when sum of a, b, c and d is 100; and a, b, c, and d is a weight percentage (wt %) of each element, respectively, based on the total weight of the NdFeB sintered magnet.

In certain embodiments, the NdFeB sintered magnet may be commercially available or be obtained in any known methods.

In an exemplary embodiment, the NdFeB sintered magnet may be prepared as follows, without limitation. A raw material mixture may be obtained by mixing raw materials, thereby forming the mixture to have the composition of the NdFeB sintered magnet as described above. The raw materials may be in a form of an elemental powder, an oxide, or a salt such as a carbonate or a hydroxide, all of which include at least one of the metal elements in the composition of the NdFeB sintered magnet as described above. Subsequently, the obtained raw material mixture may be placed in a furnace such as a high frequency melting furnace and melted at a predetermined temperature, for example, at a temperature of about 1300° C. to about 1550° C., thereby providing a NdFeB alloy which may be in a form of a flake according to a strip cast method and the like.

In certain exemplary embodiments, NdFeB alloy may further be subjected to hydrogenation and/or dehydrogenation, if desired, and then may be roughly ground and finely pulverized under an inert atmosphere, for example, using a jet mill. The size of the pulverized powder may not be limited. The average size of the pulverized powder may be particularly of about 3 to 5 μm. Subsequently, the powder may be pressed under a magnetic field in an inert atmosphere to obtain a magnetically molded product.

In certain exemplary embodiments, the molded product may be subjected to a sintering process or heat treatment under vacuum or in an inert gas atmosphere to prepare a sintered magnet. The preparation of the powder and the sintered body may be carried out in an inert gas atmosphere or under vacuum to minimize the amount of foreign substances, such as carbon, oxygen and the like. When the foreign substances are included in a substantial amount, an adverse effect on the magnetic properties may be generated.

In certain exemplary embodiments, a mixed powder including a Zn-containing metal and a metal compound containing Tb or Dy may be applied onto a surface of the sintered magnet prepared as above. The mixed powder may further include at least one metal which may be in a form of a metal powder selected from the group consisting of Cu, Co, Sn, Al, Ni, and Fe. When the sintered magnet having the mixed powder applied onto its surface is subjected to a heat treatment, the rare earth element contained in the mixed powder may diffuse into the sintered magnet and/or into the major phase grain of the sintered magnet to reach near the grain boundary thereof, while the Zn element may remain substantially on the surface of the sintered magnet. Because the Zn may be a protective layer to prevent corrosion, the corrosion resistance of the surface of the sintered magnet may be improved. In addition, the heat treatment may provide an effect of coating the surface of the magnet with the Zn, and thus a reduced amount of other raw material may be required for a surface coating after the magnet processing. Moreover, the melting temperature of the Zn is substantially low while standard reduction potential of Zn is higher than the rare earth element and the iron. Accordingly, in the subsequent heat treatment, the melted Zn may cause the rare earth compound or the rare earth powder to be reduced into the rare earth metal. Consequently, a pure component of the rare earth element such as Dy, Tb, and the like may be efficiently diffused into the inner part of the grain boundary of the magnet at a high concentration.

In certain exemplary embodiments, in the mixed powder, the Zn-containing metal may include a Zn metal powder, an alloy powder including Zn and an rare earth element, an alloy powder of a first metal and Zn. In particular, the first metal may be at least one metal selected from the group consisting of Cu, Co, Sn, Al, Ni, and Fe, and a combination thereof. The alloy powder including Zn and a rare earth element may be represented by the general formula ReₐM_{b}Zn_{c}. In yet certain exemplary embodiments, Re may be Nd, Dy, Tb, Pr, Ho, or a combination thereof, M may be Cu, Co, Sn, Al, Ni, Fe, or a combination thereof. Further, a may be of about 0.01 to 99.99, of about 0.1 to 70, or particularly of about 10 to 50; b may be of about 0 to 50; c may be a balance when a+b+c is 100, and a, b, and c are a weight percentage based on the total weight of the alloy powder including Zn and a rare earth element. In still certain exemplary embodiments, for the alloy powder of the general formula ReₐM_{b}Zn_{c}, the amount of Re may be higher than that of a total amount of the heavy rare earth element such as Dy, Tb, and the like in the NdFeB sintered magnet.

In certain exemplary embodiments, in the mixed powder, the metal compound containing Tb or Dy may include a Tb metal powder, a Dy metal powder, a Tb fluoride such as TbF₃ and the like, a Tb hydride such as TbH₂ and the like, a Tb oxide, a Dy fluoride such as DyF₃, DyF, and the like, a Dy hydride such as DyH₂ and the like, a Dy oxide, a Tb-transition metal fluoride, a Tb-transition metal hydride, a Tb-transition metal oxide, a Dy-transition metal fluoride, a Dy-transition metal hydride, a Dy-transition metal oxide, or a combination thereof. The transition metal may be Co, Ni, or Fe.

In certain exemplary embodiments, in the mixed powder, the amount of each element other than Zn may not be limited but, the Zn content may be greater than or equal to about 0.3 wt % and less than or equal to about 50 wt %, or particularly, the mixed powder may have a Zn content of greater than or equal to about 1 wt %. In the aforementioned range of Zn content of about 0.3 wt % to about 50 wt %, a substantial improvement in the coercive force together with enhancement of the corrosion resistance may be obtained. The improvement may be measured in a salt spray test to a surface of the magnet.

In certain exemplary embodiments, the mixed powder may have an average particle size of less than or equal to about 10 μm. Alternatively, the mixed powder may have an average particle size ranging from about 1 μm to about 5 μm, or particularly of about 2 μm to about 3 μm. By using a powder having a particle size within the aforementioned range, the mixed powder may be uniformly and densely attached to the magnet to be treated. After the heat treatment, a surface layer including substantial amount of Zn may provide the corrosion resistance. Accordingly, costs for coating after the treatment or costs for pretreatment such as an acid cleaning prior to the coating may be reduced. The powder having an average size of greater than or equal to about 1 μm may be advantageous to reduce the production costs and prevent the corrosion. The mixed powder including fine Zn particles having a sub-micron size may be vulnerable to oxidation, and thus the heat-treatment for the grain boundary diffusion may be required to be conducted under a high vacuum state having a pressure of 10⁻⁵ Torr or lower or in an inert gas atmosphere.

In certain exemplary embodiments, the mixed powder may be prepared by any methods without limitation in the art. In an exemplary embodiment, the mixed powder may be prepared by simply mixing a Zn-containing metal, a metal compound such as a metal, a metal fluoride, a metal oxide, a metal hydride, or the like containing Tb or Dy, and optionally at least one metal selected from the group consisting of Cu, Co, Sn, Al, Ni, and Fe in a predetermined mixing ratio.

In yet certain exemplary embodiments, the mixed powder may be prepared by alloying a Zn-containing metal, a metal compound such as a metal, a metal fluoride, a metal oxide, a metal hydride, or the like) containing Tb or Dy, and optionally at least one metal selected from the group consisting of Cu, Co, Sn, Al, Ni, and Fe, and pulverizing the obtained alloy. The alloying may be conducted by generally known methods in the art. In an exemplary embodiment, the mixed powder may be obtained by melting a Zn-containing metal, a metal compound containing Tb or Dy, and optionally at least one metal selected from the group consisting of Cu, Co, Sn, Al, Ni, and Fe. Alternatively, the mixed powder may be obtained by: making a solid solution containing the same at a temperature of greater than or equal to about 700° C.; and pulverizing a solidified product.

In certain exemplary embodiments, the applying of the obtained mixed powder as described above onto a surface of the sintered magnet may be conducted by generally known method in the art. Particularly, the mixed powder may be applied on the surface of the sintered magnet by, but not limited to, spraying method, using a suspension, a barrel painting, or the like. In an exemplary embodiment, the aforementioned mixed powder may be suspended in a solvent such as water, alcohol, or the like, and a magnet to be treated may be immersed in the suspension containing the mixed powder. Subsequently, the magnet may be taken out therefrom and dried with the suspension being attached on the surface of the magnet. Alternatively, the suspension obtained by suspending the mixed powder in the above described solvent may be sprayed onto the magnet

In yet certain exemplary embodiments, a barrel painting method may be used for applying the obtained mixed powder onto the surface of the sintered magnet. In an exemplary embodiment, an adhesive material such as liquid paraffin may be applied to a surface of the magnet to be treated to thereby form an adhesive layer. The mixed powder may be blended with an impact medium such as small spheres that have an average diameter of about 1 mm and are made of a metal or a ceramic. The magnet having the adhesive layer formed thereon may be added to the resulting mixture of the mixed powder and the impact medium and then is subjected to vibration and/or agitation. Accordingly, the mixed powder may be attached to the adhesive layer by the impact medium, and be applied to the surface of the magnet to be treated.

According to various exemplary embodiments of the present invention, the mixed powder may be applied as decrived above to avoid a film formation process which may occur during vapor deposition or sputtering, as such production in large quantity may be facilitated and productivity thereof may be improved. In addition, a large volume of the magnets may be loaded during the subsequent heat treating without being fused together.

In certain exemplary embodiments, the thickness of the applied layer of the mixed powder may be greater than or equal to about 5 μm and in particular, the thickness of the applied layer of the mixed powder may be less than or equal to about 150 μm. When the mixed powder has the thickness within the aforementioned range, wasting of the expensive Dy powder may be prevented and the effect of increasing the coercive force via the grain boundary diffusion may be improved.

The sintered magnet having the mixed powder applied on the surface thereof may be thermally treated or heat-treated. In certain exemplary embodiments, the heat treating may be carried out in an atmosphere of an inert gas such as nitrogen, helium, argon, or the like, or under a highly vacuum state less than or equal to about 10⁻⁵ Torr. In yet certain exemplary embodiments, the heat-treating may be carried out at a temperature of about 700° C. to about 950° C. In still certain exemplary embodiments, the heat-treating may be carried out for about 1 hour to about 10 hours. In an exemplary embodiment, the heat-treating may be carried out at a temperature of about 750° C. to 850° C. for a time period of less than or equal to about 9 hours. In another certain exemplary embodiments, after the heat-treating, the magnet may be cooled rapidly and may then be subjected to an additional heat treatment, if desired. In an exemplary embodiment, the magnet may be cooled rapidly from the heat-treating temperature to room temperature, and then it may be re-heated to about 500° C. and subsequently be cooled rapidly to room temperature. In other exemplary embodiment, the magnet may be cooled slowly from the heat-treating temperature to about 600° C. and rapidly therefrom to room temperature, and then it may be re-heated to about 500° C. and subsequently be cooled rapidly to room temperature. Such a rapid cooling treatment may result in improvement on the fine structure of the grain boundary of the sintered magnet, thereby further enhancing the coercive force.

In still certain exemplary embodiments, in the heat-treating, the heavy rare earth element such as Dy and/or Tb may diffuse through the grain boundary of the sintered magnet at a high concentration and a high purity. In addition, the heat-treating may provide the surface of the sintered magnet with a surface treatment of the Zn.

When the sintered body is heat-treated after the powder of the rare earth inorganic compound such as a fluoride or oxide is applied to the surface thereof, the vapor deposition and the sputtering may not be necessary, and thus the process itself may be simplified as an advantage. However, Dy and/or Tb may diffuse only via the substitution of the given inorganic powder with the components of the magnet, and thus introducing the Dy and/or Tb in a large quantity into the magnet may be difficult and the coercive force may hardly increase. However, according to various exemplary embodiments of the present invention, as the Zn contained in the mixed powder has a low melting point and a high level of standard reduction potential, the Dy and/or Tb may uniformly diffuse into the magnet in a larger quantity in comparison to the case where the powder without Zn is used, and thereby the coercive force may significantly increase.

In the related art using the grain boundary diffusion method, a calcium powder or a hydrogenated calcium powder is mixed with the oxide or fluoride including Dy or Tb and the resulting powder mixture is applied to the magnet. Such a mixture may provide an advantage in that a larger amount of Dy or Tb may be introduced. However, the calcium powder or the hydrogenated calcium powder may not be handled easily, and thus the final productivity may hardly increase. In contrast, since the mixed powder as used in various exemplary embodiments of the present invention is not difficult to handle, the productivity of the process may substantially increase.

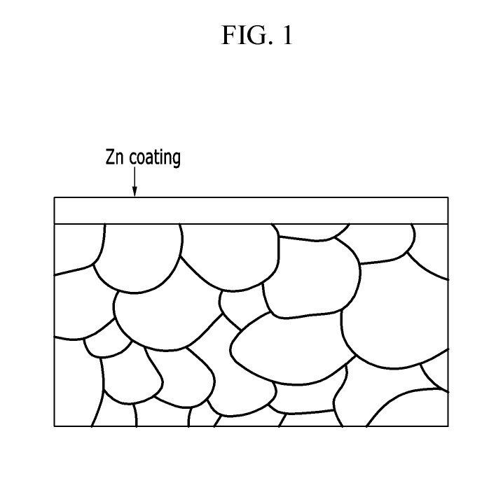

Moreover, in the related art, the magnet treated by the grain boundary diffusion with the heavy rare earth element may be further subjected to a process for removing an oxide film formed on the surface of the magnet. However, such a process may result in a reduced diffusion depth, which has been considered as one of the problems of the grain boundary diffusion method. According to various exemplary embodiments of the present invention, as shown in FIG. 1, the treated magnet may have a surface being treated with Zn, which may provide improved corrosion or etching resistance to the magnet surface. Therefore, the amount of diffused heavy rare earth elements being removed during the removing the oxide layer after the grain boundary diffusion method may be minimized.

In another aspect, a NdFeB sintered magnet is provided. The NdFeB sintered magnet may be prepared from the aforementioned production method. In particular, the surface of the sintered magnet may have a layer including substantial amount of Zn, as schematically illustrated in FIG. 1. The sintered magnet may have improved corrosion or etching resistance in comparison with an untreated sintered magnet. In certain exemplary embodiments, the sintered magnet of the present invention may have improved corrosion resistance of greater than or equal to about 2 hours, of greater than or equal to about 4 hours, or particularly of greater than or equal to about 6 hours as measured by a salt spraying test according to ASTM B 117.

The following examples illustrate an exemplary embodiment of the present invention in more detail. However, it is understood that the scope of the present invention is not limited to these examples.

### Examples 1 to 10 and Comparative Example 1 to 3

### [1] Production of Sintered Magnet

A NdFeB sintered magnet having composition Al as below is used as a sintered magnet.

TABLE 1

| | Nd | Pr | Dy | Tb | Fe | Co | B | Al | Cu | C | O | notes |
|---|---|---|---|---|---|---|---|---|---|---|---|---|
| A1 | 27 | 1 | 1 | 1 | Balance | 2 | 1 | 0.5 | 0.25 | 0.01 | 0.12 | Total: |
| (wt %) | | | | | | | | | | | | 100% |

The sintered magnet may be prepared as follows.

A mixture is prepared by mixing Nd, Pr, Dy, Tb, Fe, Co, B, Al, and Cu in the amount as set forth in Table 1. The mixture is melted in a high frequency melting furnace at a temperature of about 1300° C. to 1550° C. and prepared as NdFeB flakes by a strip cast method. Subsequently, the NdFeB flakes are coarsely ground via hydrogenation and dehydrogenation, and are pulverized to have a size of about 3 μm to 5 μm in an inert gas atmosphere with a jet mill. The pulverized powder is prepared as a molded product using a magnetic field molding press, and the direction of the magnetic field is perpendicular to the direction of the pressurization. The molded product is sintered and heat-treated under vacuum to obtain a sintered body.

### [2] Grain Boundary Diffusion

A mixed powder is prepared by mixing a Zn metal powder, an Al metal powder, a Cu metal powder, a Dy metal powder, a Co metal powder, a TbH₂ powder, and a TbF₃ powder at a composition ratio set forth in Table 2. The mixed powder is applied to a surface of the magnetic sintered body as prepared in [1] using a barrel painting method. The sintered body having the mixed powder applied thereon is heat-treated under an argon atmosphere at a pressure higher than a normal pressure at a temperature and time conditions being set forth in Table 2.

TABLE 2

| | | | A mixing ratio of the mixed | Grain boundary | |
|---|---|---|---|---|---|
| | | Diffusing | powder (based on weight) | diffusion | |
| | Diffusing | rare earth | Diffusing metal:Diffusing | Temp. | Time |
| | metal | metal | rare earth metal | (° C.) | (hrs) |
| Example 1 | Zn | TbH2 | 10:90 | 800 | 4 |
| Example 2 | Zn | TbH2 | 1:99 | 800 | 4 |
| Example 3 | Zn50Al50 | TbH2 | 1:99 | 800 | 4 |
| Example 4 | Zn50Cu50 | TbH2 | 50:50 | 800 | 4 |
| Example 5 | Zn | TbF3 | 10:90 | 800 | 4 |
| Example 6 | Zn | TbF3 | 70:30 | 800 | 4 |
| Example 7 | Zn50Al50 | TbF3 | 30:70 | 800 | 4 |
| Example 8 | Zn50Cu50 | TbF3 | 50:50 | 800 | 4 |
| Example 9 | Dy20Zn80 | TbF3 | 50:50 | 800 | 4 |
| Example 10 | Dy20Co30Zn50 | TbF3 | 50:50 | 800 | 4 |
| Comp. | none | TbH2 | 0:100 | 800 | 4 |
| Example 1 | | | | | |
| Comp. | none | TbF3 | 0:100 | 800 | 4 |
| Example 2 | | | | | |
| Comp. | none | none | 0:100 | 800 | 4 |
| Example 3 | | | | | |

Evaluation of Magnetic Performance

[1] Measurements of Residual Magnetic Flux Density, Coercive Force, and Maximum Energy Product

In accordance with a vibrating sample magnetometer (VSM) method or a BH loop tracer method, magnetic hysteresis curves for the sintered magnet of Examples 1 to 10 and Comparative Examples 1 to 3 are obtained. The maximum magnetic field as applied is about 2.5 T or greater, and the sweeping of the magnetic field is conducted to obtain the magnetic hysteresis curves and the demagnetization curves. From the obtained curves, a residual magnetic flux density and the coercive force are measured and the maximum energy product (BH) is calculated therefrom. The results are shown in Table 3 below.

[2] Corrosion Resistance Evaluation: A Salt Spraying Test

Corrosion resistance is evaluated in accordance with ASTM B 117, and the results are compiled in Table 3 below.

TABLE 3

| | | | | Corrosion |
|---|---|---|---|---|
| | Magnetic Properties | | | Resistance |
| | Br(kG) | | BHmax(MGOe) | SST(h) |
| | (residual | iHc(kOe) | Maximum | (salt |
| | magnetic flux | (coercive | energy | spraying |
| | density) | force) | product | test) |
| Example 1 | 12.9 | 21.8 | 43.2 | 14 |
| Example 2 | 12.9 | 21.8 | 43.2 | 14 |
| Example 3 | 12.8 | 19.4 | 43.1 | 14 |
| Example 4 | 12.7 | 19.9 | 42.9 | 14 |
| Example 5 | 12.8 | 23.4 | 42.9 | 14 |
| Example 6 | 12.8 | 23.4 | 42.9 | 16 |
| Example 7 | 12.8 | 22.6 | 42.9 | 16 |
| Example 8 | 12.7 | 22.5 | 42.7 | 16 |
| Example 9 | 12.8 | 23.6 | 42.8 | 12 |
| Example 10 | 12.7 | 23.7 | 42.8 | 12 |
| Comp. | 12.6 | 18.5 | 42.7 | 10 |
| Example 1 | | | | |
| Comp. | 12.7 | 18.3 | 42.6 | 10 |
| Example 2 | | | | |
| Comp. | 12.8 | 16.5 | 42.8 | 10 |
| Example 3 | | | | |

As shown in Table 3, the magnet of Examples 1 to 10 may have enhanced coercive force without any substantial decrease of the residual magnetic flux density. In addition, the magnets of the examples may have corrosion resistance which is substantially improved in comparison with the magnets of the comparative examples.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of producing a rare earth permanent magnet, comprising:
obtaining a NdFeB sintered magnet;
applying a mixed powder including a Zn-containing metal and a metal compound containing Tb or Dy onto a surface of the sintered magnet; and
heat-treating the sintered magnet having the mixed powder applied on its surface.

2. The method of claim 1, wherein the NdFeB sintered magnet has a composition of Chemical Formula 1:
ReₐM_{b}Fe_{c}B_{d} [Chemical Formula 1]
wherein Re is at least one rare earth metal selected from the group consisting of Nd, Dy, Tb, and Pr and Re essentially includes Nd;
M is at least one metal selected from the group consisting of Co, Al, Cu, Ga, Zr, and Nb,
a is a real number of 25 to 35, b is a real number of 0 to 10, d is a real number of 0.1 to 5, c is a balance, provided that a+b+c+d=100, and a, b, c, and d represent a weight percentage of each element, respectively.

3. The method of claim 1, wherein the mixed powder further comprises at least one metal selected from the group consisting of Cu, Co, Sn, Al, Ni, and Fe.

4. The method of claim 1, wherein in the mixed powder, the Zn-containing metal comprises: a Zn metal powder, an alloy powder including Zn and a rare earth element, an alloy powder of a first metal and Zn, the first metal is at least one metal selected from the group consisting of Cu, Co, Sn, Al, Ni, and Fe, and a combination thereof.

5. The method of claim 1, wherein in the mixed powder, the metal compound containing Tb or Dy comprises: a Tb metal powder, a Dy metal powder, a Tb fluoride, a Tb hydride, a Tb oxide, a Dy fluoride, a Dy hydride, a Dy oxide, a Tb-transition metal fluoride, a Tb-transition metal hydride, a Tb-transition metal oxide, a Dy-transition metal fluoride, a Dy-transition metal hydride, a Dy-transition metal oxide, or a combination thereof.

6. The method of claim 1, wherein a Zn content of the mixed powder is greater than or equal to about 0.3 wt % and less than or equal to about 50 wt %.

7. The method of claim 6, wherein the mixed powder has the Zn content of greater than or equal to about 1 wt %.

8. The method of claim 1, wherein the mixed powder has an average particle size of less than or equal to about 10 μm.

9. The method of claim 8, wherein the mixed powder may have an average particle size ranging from about 1 μm to about 5 μm.

10. The method of claim 1, wherein the mixed powder is a mixture comprising a Zn-containing metal, a metal compound containing Tb or Dy, and optionally at least one metal selected from the group consisting of Cu, Co, Sn, Al, Ni, and Fe.

11. The method of claim 1, wherein the mixed powder is obtained by alloying a Zn-containing metal, a metal compound containing Tb or Dy, and optionally at least one metal selected from the group consisting of Cu, Co, Sn, Al, Ni, and Fe and pulverizing the obtained alloy.

12. The method of claim 1, wherein the mixed powder is obtained by melting a Zn-containing metal, a metal compound containing Tb or Dy, and optionally at least one metal selected from the group consisting of Cu, Co, Sn, Al, Ni, and Fe; and pulverizing the obtained alloy.

13. The method of claim 1, wherein the mixed powder is obtained by making a solid solution containing a Zn-containing metal, a metal compound containing Tb or Dy, and optionally at least one metal selected from the group consisting of Cu, Co, Sn, Al, Ni, and Fe at a temperature of greater than or equal to about 700° C.; and pulverizing a solidified product thus obtained after solidification.

14. The method of claim 1, wherein the applying of the mixed powder including a Zn-containing metal and a metal compound containing Tb or Dy onto the surface of the sintered magnet comprises: immersing the sintered magnet in a suspension containing the mixed powder in an organic solvent; removing the magnet having the suspension attached to the surface thereof from the suspension; and drying the magnet.

15. The method of claim 1, wherein the applying of the mixed powder including a Zn-containing metal and a metal compound containing Tb or Dy onto the surface of the sintered magnet comprises: spraying a suspension containing the mixed powder in an organic solvent to the surface of the sintered magnet; and drying the same.

16. The method of claim 1, wherein the applying of the mixed powder including a Zn-containing metal and a metal compound containing Tb or Dy onto the surface of the sintered magnet comprises: forming an adhesive layer on the surface of the sintered magnet; obtaining a mixture of the mixed powder and a metallic or ceramic impact media; placing the sintered magnet having the adhesive layer on the surface thereof in the mixture; and vibrating and agitating the same.

17. The method of claim 1, wherein the heat-treating of the sintered magnet having the mixed powder applied onto the surface thereof is carried out under an inert gas atmosphere or under a high vacuum state.

18. The method of claim 1, wherein the heat-treating is carried out at a temperature of about 700° C. to about 950° C.

19. A rare earth sintered magnet produced by the method of claim 1.

20. The magnet of claim 19, wherein the magnet has corrosion resistance of greater than or equal to about 11 hours in a salt spraying test in accordance with ASTM B 117.
